(19) United States
(12) Patent Application Publication
(10) Pub. No.: US 2008/0204200 A1
(43) Pub. Date: Aug. 28, 2008

(54) Systems and methods of locating raido frequency identification tags by radio frequencey technology

(76) Inventors: Huilong Zhu, Poughkeepsie, NY (US); Huicai Zhong, Wappingers Falls, NY (US)

Correspondence Address: Huilong Zhu;Huicai Zhong, 93 Autumn Drive, Poughkeepsie, NY, 12603, US

(21) Appl. No.: 11/710,673

(22) Filed: Feb. 26, 2007

(51) Int. Cl. G01S 1/02

(52) U.S. Cl. 340/10.3

(57) ABSTRACT

Methods and systems with one or more mobile transceivers to locate position of radio frequency identification (RFID) tags via radio frequency (RF) technology are disclosed. The systems called RF Locator (RFL) include at least one mobile RF transceiver and other functional components such as, a globe positioning system (GPS), a processor, and a display. Information of space positions, times and physical characteristics related to RF signals are collected sequentially by the mobile transceiver(s) during RFID tag locating process. The processor calculates the location of the RFID tag by using the collected information. Two methods to determine the location of the RFID tag are disclosed in this invention. The first method is to utilize the information of space positions and times. The second method is to use the information of space positions and RF signal characteristics.

### FIELD OF THE INVENTION

The present invention relates to the field of radio frequency (RF) technology, and in particular to systems and methods for using RF technology to determine location of RFID tags. More specifically, the present invention relates to methods and systems for locating RFID tags by using RF and RFID technology.

### BACKGROUND OF THE INVENTION

The invention described below related to systems and methods using radio frequency (RF) technology to locate RF devices. The use of RF technology to locate objects that are equipped with a passive RF device such as an RF identification (RFID) tag (an electronic tag that sends out an RFID signal when it is activated by an RF signal) and/or active device such as RF transmitter is widely known in prior arts. In conventional RF locating systems described by U.S. Pat. Nos. 6,661,335 and 6,396,438, at least three RF transceivers are required in order to locate RFID tags. These transceivers generate and transmit RF signals in an area determined by the strength of the RF signal and locations of the RF transceivers relative to the area of projection. For example, in a warehouse environment where to locate RFID tag is necessary, a number of RF transceivers may be placed in fixed positions such as in the ceiling of the warehouse. The transceivers are placed at a certain distance apart from each other to reach the edges of the signals from their neighboring RF transceivers. The transmitted RF signals are received by RF devices designed to respond to receipt of the RF signal by transmitting/broadcasting an identification signal in return. A common RF device is an RFID tag, which has a passive electronic component that transmits a signal containing a stored ID of the tag whenever RF interrogation signals transmitted by the transceivers are received by the RFID tag. A coil within the tag is energized and causes an internal chip to rebroadcast the tag's ID information, which can be received by the interrogation device (i.e. RF transceiver for this case).

Typical RFID tags are omni-directional devices that do not enable the devices themselves to receive or transmit directional signals, which makes it impossible for a transceiver to find the direction pointing to RFID tag even the distance between the RFID tag and the transceiver is known. Because of this limitation, locating the particular RFID device requires multiple RF interrogation devices at different locations. In previous RF locating applications described in U.S. Pat. No. 6,963,289, reading of RF signal strengths or arrival times from multiple interrogation RF devices at different locations are required to triangulate the position of an RFID device through methods such as Time-Difference-of-Arrival (TDOA), received signal strength indication (RSSI) or other triangulation techniques. In this case, at least three transceivers at three different locations are required to determine the location of the RFID tag. It is well known that there is variation even among the same type of transceivers due to the difference in radio circuits. As a result, this process inevitably results in errors due to RFID signal strength dependent on many factors such as interrogation device signal strength, distance between interrogation device and RFID tag. In order to improve the accuracy, even more transceivers are required to interrogate the RFID tag.

In order to achieve locating RFID tag positions in a large area, a large number of interrogation devices are required since the short broadcasting distance of RFID tag (typically less than a few hundred feet). Using such a big number of sophisticated logic equipments means very high cost. On the other hand, the installation of many transceivers requires lots of effort and time. Especially, it is not cost effective if the RF locating system is not for frequent application purpose. Furthermore, it is obvious that a locating system with such a large number of transceivers is not flexible. Additional expense for each interrogation device has to be powered all the time and connected to main processing system for triangulating computation. Because the number of interrogation devices is always limited, the position of RFID tag located by limited triangulation method is inaccurate as the signal strength of the tag received by respective interrogation devices varies as the function of distance between RFID tag and device and other factors.

The substantial cost in utilizing a large number of interrogation devices to locate RFID tag prevents the application of such a system from being widely used. The present invention provides a practical solution to overcome the limitations found in prior arts. With the methods disclosed in this invention, the number of interrogation device as small as one is required for locating RFID tag. Furthermore, with methods disclosed in present invention, undesired effect of variations among transceivers on the accuracy of the RFID tag location determined by transceivers can be reduced. Using only one interrogation device to locate RFID tag location may significantly reduce the dependency on RF signal variations. The accuracy of the RFID location determined by a number of transceivers depends on the variation of transceivers' properties. The larger the variation the lower the accuracy is. In present invention, one transceiver is enough to determine the RFID location. Therefore, the variation from transceivers is minimized.

A further look at the background of RFID and locating technology can be obtained from a list of U.S. Pat. Nos. 6,747,560; 6,614,392; 6,204,765; 6,215,402; and 6,429,775 with all of these patents herein incorporated by reference. Also large amount of information regarding RFID technology is available on the Internet, some of if from the providers of the technology for the education of their customers

### SUMMARY OF THE INVENTION

The need in the systems and methods of the present invention is addressed. Disclosed in this invention are systems and methods to locate the position of radio frequency identification (RFID) tags via radio frequency (RF) technology. A monitored area is labeled with at least one RFID tag. Any RFID tag in the monitored area responds to receipt of an interrogation RF signal by transmitting/broadcasting its ID within a circled area centered by the RFID tag. The circled area may be dependent on the physical characteristics of the RF signal such as, but not limited to, RF signal strength and frequency.

A system, an RF Locator (RFL), includes at least one mobile RF transceiver and other functional components such as, a globe positioning system (GPS), a processor with logic and memory units, and a display. The RFL is placed close enough to the RFID tag to be located so that both of them can receive RF signals from each other. At first, the RFL sends out an interrogation RF signal at a known space position and at a known time. The physical characteristics such as, but not limited to, RF signal frequency and strength, of the interrogation RF signal sent out by the RFL may be related to the system itself. The RFL's space position could be predetermined by a global positioning system (GPS) or other known methods. The time could be determined by a clock such as an atomic clock. The RFID tag receives the interrogation RF signal transmitted by the RFL and responds to it by transmitting/broadcasting an RF signal to the RFL. The RF signal broadcasted by the RFID tag is called RFID signal. The RFID signal contains RF signal information including, but not limited to, RF signal frequency, RFID sign al strength and ID information of the RFID tag. At another known time point determined by a clock, the RFL receives the RFID signal from the RFID tag at a predetermined space position. The space position where the RFL receives the RFID signal can be either the same or different from the space position where the RFL sends out the interrogation RF signal. The information of the space position where the RFL transmits RF signal and the space position where the RFL receives the RFID signal can be determined by known method such as, but not limited to, a global positioning system (GPS). The time when the RFL receives the RFID signal from the RFID tag can be determined by known methods such as, but not limited to, an atomic clock. The information of the physical characteristics related to both the interrogation RF signal and RFID signal along with the information of the space positions and times could be transferred and saved to the processor. The processor then uses the saved information to determine the location of the RFID tag. The display is used to display the information, such as the positions of the RFL and the RFID tag.

Two methods to determine the location of the RFID tag by utilizing the information collected by the system mentioned above are disclosed in this invention.

The first method is to utilize the information of the space positions and times collected by the system in a time sequence. The processor tries to calculate the location of the RFID tag by using the saved information of the space positions and times. If the saved information of the space positions and times is not enough to determine the RFID tag location with desired accuracy, the RFL is moved to another known space position. At the new known space position and new time point, the RFL transmits an interrogation RF signal to activate the RFID tag again. The RFID tag receives the interrogation RF signal and responds to it by transmitting/broadcasting an RFID signal to the RFL. The RFL receives the RFID signal from the RFID tag at a known time point and a predetermined space position. In this way the system obtains additional information related to the RFID tag, which is useful for determining the location of the RFID tag. The space position where the RFL receives the RFID signal can be the same or different from the space position where the RFL sends out the interrogation RF signal. To prepare for next RFID tag location calculation, the system collects and saves all additional information of the new space positions and times and/or physical characteristics of RF signals related to both the RFL and the RFID tag. This process for collecting additional information of space positions, times and/or physical characteristics of both RF and RFID signal by relocating the system is called relocation-collection process. The processor tries to calculate the location of the RFID tag again by using newly collected information of the space positions and times in addition to the previously saved information of space positions and times. If the saved information of the space positions and times is not enough to determine the RFID tag location with desired accuracy, the system starts a new round of relocation-collection process and the corresponding RFID location calculation until the desired accuracy of the RFID tag location is achieved.

The second method to locate the RFID position is to utilize the information of RFL space positions and physical characteristics of the RF signals transmitted by the RFL and/or RFID tag. The processor tries to calculate the location of the RFID tag by using the saved information of space positions and physical characteristics of RF signals. If the saved information of the space positions and physical characteristics of RF signals is not enough to determine the RFID tag location with desired accuracy, the RFL is moved to another known space position and starts a new relocation-collection process. The processor tries again to calculate the location of the RFID tag by using the additional collected information of RFL space positions and RF signal physical characteristics together with the previously saved information of the RFL space positions and RF signal physical characteristics until desired accuracy of the RFID tag location is achieved. The physical characteristics of RF signals include, but not limited to, strength and Doppler shift of the wavelength and/or frequency of the RFID signal.

The above, as well as additional objectives, features, and advantages of the present invention will become apparent in the following detailed written description.

### BRIEF DESCRIPTION OF THE DRAWINGS

The novel systems and methods to determine the location of an RFID tag by using time-space or space-signal information of the RFID tag and an RFID position locating system is introduced as below.

FIGS. 1-4 show methods and systems using RF technology to determine the location of an RFID tag for this invention. An RFID tag position locating system, an RF Locator (RFL), includes at least one mobile RF transceiver and other functional components such as, but not limited to, a globe positioning system, a processor with memory units, and a display. The RFL is used to collect necessary information for determining the location of the RFID tag. The mobile RFL sends out an interrogation RF signal, say the i^{th} signal (i=1, 2, . . . , n), at the known space point of (Xᵢ, Yᵢ, Zᵢ) and the known time of tᵢ, where Xᵢ, Yᵢ, Zᵢ are the space coordinates of the RFL space position. The i^{th} time-space point is defined as (Xᵢ, Yᵢ, Zᵢ, tᵢ,). The space coordinates can be known by a global positioning system (GPS) located at the place where the i^{th} RF signal is sent out or pre-known by other methods. The time of tᵢ can be obtained by a clock such as, but not limited to, an atomic clock or other known methods. The physical characteristics such as, but not limited to, RF signal frequency and strength, of the interrogation RF signal sent out by the RFL may be related to the system itself. The RFID tag receives the interrogation RF signal transmitted by the RFL and responds to it by transmitting/broadcasting an RF signal to the RFL. The RF signal sent out by the RFID tag, containing the ID of the RFID tag, is called RFID signal. The RFL receives the RFID signal with certain signal strength at another time-space point (X′ᵢ, Y′ᵢ, Z′ᵢ, tᵢ′). The space coordinates (X′ᵢ, Y′ᵢ, Z′ᵢ) can be the same or different from space coordinates (Xᵢ, Yᵢ, Zᵢ). Usually, in order to successfully determine the location of the RFID tag, the number of i is equal or bigger than 3. The larger the number of i is, the higher accuracy of the calculated location of the RFID tag is. Generally speaking, to collect additional time-space points and/or physical characteristics of RF signals related to both the RFL and RFID tag, the RFL is moved to a new known time-space point and repeats the steps of sending out an interrogation RF signal, receiving an RFID signal from the RFID tag and collecting additional information of time-space points and/or physical characteristics of RF signals. This process for collecting additional information by relocating the system to new known positions is called relocation-collection process.

A processor saves all the information including time-space points and/or physical characteristics of the RF signals related to both the RFL and the RFID tag. The processor can be integrated within the RFL or connected to the RFL externally. The processor has a memory unit and uses the saved information to try to determine the location of the RFID tag.

The processor may use either one or the combination of the following two methods to try to determine the RFID tag location. One method is to use the saved time-space information to determine the location of the RFID tag such as the method of Time-Difference-of-Arrival. The other method is to use the saved information of space of the RFL and physical characteristics of the RF signals related to both the RFL and the RFID tag, for example, the method of using received signal strength, to determine the RFID tag location.

If the saved information is not enough for the processor to determine the location of the RFID tag with desired accuracy, additional information is collected by a new relocation-collection process. The processor tries again to determine the location of the RFID tag with the additional collected information together with previously saved information. The system is used to repeat the above process until the location of the RFID tag is determined with desired accuracy.

### DETAILED DESCRIPTION OF ILLUSTRATIVE EMBODIMENT

Illustrative embodiments and exemplary applications will now be described with reference to the accompanying drawings to reveal the advantages of this invention. It is noted that the drawings of the present application are provided for illustrative purposes and, as such, they are not necessarily drawn to scale.

The present invention discloses methods and systems to locate the position of a radio frequency identification (RFID) tag via radio frequency (RF) technology in a monitored area.

An RFID tag position locating system, an RF Locator (RFL), includes at least one mobile RF transceiver and other functional components such as, but not limited to, a globe position system, a processor with memory units, and a display. The processor can be either integrated within the RFL or connected to the RFL externally with cable connection and/or wireless communication. The RFL is placed close enough to the RFID tag so that the RFL could 1) activate the RFID tag by transmitting an interrogation radio frequency (RF) signal and 2) receive an RF signal from the responding RFID tag.

The monitored area is labeled with at least one RFID tag, whose location within the monitored area is desired to be known. The one or multiple RFID tags are positioned in an area close to the RFL enough to allow the RFL to receive RF signals from the RFID tag. The RFID tag responds to receipt of an interrogation RF signal from the RFL by transmitting/broadcasting an RF signal within a circled area centered by the RFID tag. The circled area may be dependent on RF signal strength and other factors.

At a known time point, the RFL is placed at a known space position and transmits an interrogation RF signal. The time point can be measured by a clock such as, but not limited to, an atomic clock or other methods. The information of the RFL space position can be obtained by a global positioning system (GPS) or be known by other methods. The physical characteristics such as, but not limited to, RF signal frequency and strength, of the interrogation RF signal sent out by the RFL may be related to the system itself. After the RFL sends out an interrogation RF signal, the RFID tag responds to the interrogation RF signal from the RFL by broadcasting an RF signal with its identification (ID) of the RFID tag. The responding RF signal from the RFID tag is called RFID signal. The RFID signal broadcasted by the RFID tag contains RF signal information including, but not limited to, frequency, signal strength and ID information of the RFID tag. The RFL receives the RFID signal from the RFID tag at a known space position and known time point. The space position where the RFL receives the RFID signal can be the same or different from the space position where the RFL sends out the interrogation RF signal. The information of the space position where the RFL transmits RF signal and the space position where the RFL receives the RFID signal can be determined by known method such as, but not limited to, a global positioning system (GPS). The information of the time when the RFL transmits the interrogation RF signal and the time when the RFL receives the RFID signal from the RFID tag can be determined by known methods such as, but not limited to, an atomic clock. The information of physical characteristics related to both the interrogation RF signal and the RFID signal along with the information of the space positions and times could be transferred and saved to the processor. The processor then utilizes the saved information to try to determine the location of the RFID tag.

The processor may use either one or the combination of the following two methods to determine the RFID tag location. One method is to use the saved information of the RFL space positions and times to determine the RFID tag location such as the method of Time-Difference-of-Arrival. The other method is to use the saved information of the RFL space positions and RF signal physical characteristics related to both the RFL and the RFID tag to determine the RFID tag location for example, the method of received signal strength indication. The processor utilizes the saved information to try to calculation the location of the RFID tag through either one or the combination of the two methods.

Usually, in order to successfully determine the location of the RFID tag, the system needs to collect information at least three different RFL space positions where the RFL sends out interrogation RF signals. The more information the system collects, the higher accuracy of the calculated location of the RFID tag is. Generally speaking, in order to collect additional information of space positions where RF signals are transmitted and received, times when RF signals are transmitted and received, and/or physical characteristics of RF signals related to both the RFL and RFID tag, it is required that the RFL is moved to a new known space position. To obtain enough information to determine the location of the RFID tag, it needs to go through several times the steps of sending out an interrogation RF signal, receiving a RFID signal from the RFID tag and collecting additional information of the space positions where RF signals are transmitted and received, the times when RF signals are transmitted and received, and/or the physical characteristics of RF signals related to both the RFL and the RFID tag. This process for collecting additional information by relocating the system to new known space positions is called relocation-collection process.

If the information is not enough for the processor to determine the location of the RFID tag with desired accuracy, additional information is obtained by conducting a new round of relocation-collection process. After the new relocation-collection process, the processor tries again to determine the location of the RFID tag with the additional collected information and previously saved information. The system is used to go through the above process and to collect the corresponding new information until the location of the RFID tag is determined with desired accuracy.

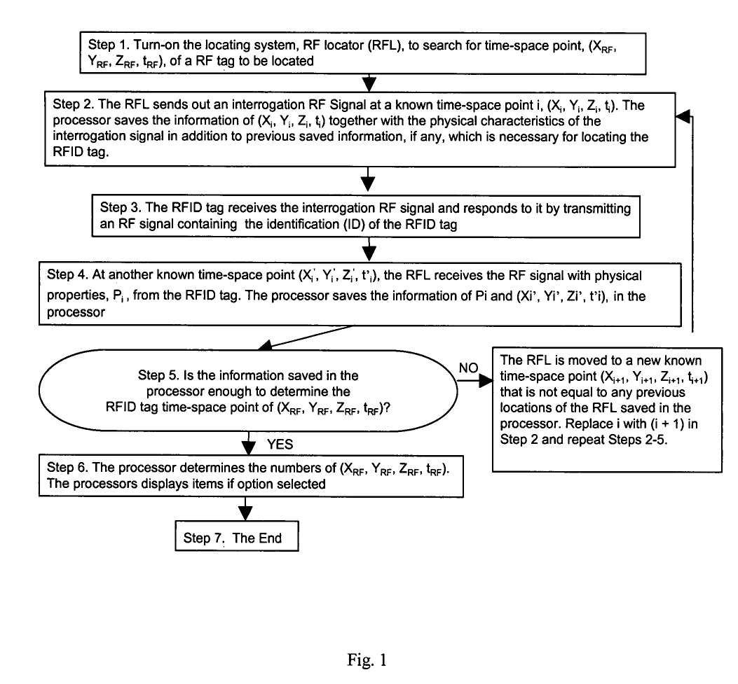

FIG. 1 describes a flowchart using a mobile RFL system to determine the location of an RFID tag. To collect necessary information, in one embodiment, the mobile RFL system is moved to different locations to transmit and receive RF signals in a time sequence. At Step 1, the system is turned on to start to search for location information of an RFID tag to be located within a certain distance. At Step 2, the RFL sends out an interrogation RF signal at the i^{th} time-space point (Xᵢ, Yᵢ, Zᵢ, tᵢ), i=1, 2, . . . , where (Xᵢ, Yᵢ, Zᵢ) and tᵢ represent the i^{th} space coordinates of the RFL and the i^{th} time when the RFL sends out the RF signal, respectively. The space coordinates, (Xᵢ, Yᵢ, Zᵢ), i=1, 2, . . . , of the RFL can be known by a global positioning system (GPS) or predetermined by other methods. The times, tᵢ, i=1, 2, . . . , can be determined by a clock such as an atomic clock or other methods. The physical characteristics such as, but not limited to, RF signal frequency and strength, of the interrogation RF signal sent out by the RFL may be related to the system itself. The time-space information together with the physical characteristics of the interrogation RF signal is transferred and saved to a processor in addition to previous saved information, if any, which is necessary for locating the RFID tag. The processor can be integrated within the RFL or connected to the RFL externally. At Step 3, the RFID tag receives the interrogation RF signal from the RFL and responds by broadcasting an RF signal containing ID information of the RFID tag and other physical characteristics including, but not limited to, frequency and signal strength. The RF signal sent out by the RFID tag is called RFID signal. At Step 4, at another known space point with known space coordinates, say (Xᵢ′, Yᵢ′, Yᵢ′), and another time, say tᵢ′, which forms time-space point (Xᵢ′, Yᵢ′, Yᵢ′, tᵢ′), the RFL receives the RFID signal including ID information of the RFID tag with physical properties, represented by Pᵢ. The space position (Xᵢ, Yᵢ, Zᵢ) can be either the same or different from the space position (Xᵢ′, Yᵢ′, Yᵢ′). The Pᵢ includes, but not limited to, physical characteristics such as signal strength and Doppler shift of the wavelength and/or frequency of the RFID signal, broadcasted by the RFID tag which is activated by the interrogation RF signal. The information of Pᵢ and time-space point (Xᵢ′, Yᵢ′, Zᵢ′, tᵢ′) is transferred to and saved by the processor. If in the period of time between time tᵢ and tᵢ′ the RFL moves within a negligible distance, one has (Xᵢ, Yᵢ, Zᵢ) equals to (Xᵢ′, Yᵢ′, Zᵢ′). At Step 5, the processor uses the saved information to try to determine the location of the RFID tag. If the system is able to determine the RFID tag location, at Step 6, the processor determines the numbers of space coordinates (X_{RF}, Y_{RF}, Z_{RF}) and a set of characteristic properties ξ_{RF} of the RFID tag and display items if display option is selected. The set of characteristic properties ξ_{RF} includes, but not limited to, systematic response delay time, which may be needed for calculating RFID tag location.

Usually, in order to successfully determine the location of the RFID tag, the number of i is equal or bigger than 2. The larger the number of i, the higher accuracy of the calculated location of the RFID tag is. Generally speaking, to collect additional information of time-space points and/or physical characteristics of RF signals related to both the RFL and RFID tag, the RFL is moved to a new known time-space point and repeats the steps of sending out an interrogation RF signal, receiving an RFID signal from the RFID tag and collecting additional information of time-space points and/or physical characteristics of RF signals related to both the RFL and the RFID tag. This process for collecting additional information by relocating the system to new known positions is called relocation-collection process.

If the saved information is not enough to determine the RFID tag location with desired accuracy, the system starts a new relocation-collection process to collect additional information to determine the RFID tag location. The RFL is moved to a new space position with known space coordinates (Xᵢ₊₁, Yᵢ₊₁, Zᵢ₊₁) that is not equal to any previous locations of the RFL saved in the processor and a new round of relocation-collection process is conducted. Additional information is obtained after finishing the new round of the relocation-collection process. Then the processor tries again to determine the location of the RFID tag with the additional information and previously saved information. The system repeats the above process until the location of the RFID tag is determined with desired accuracy.

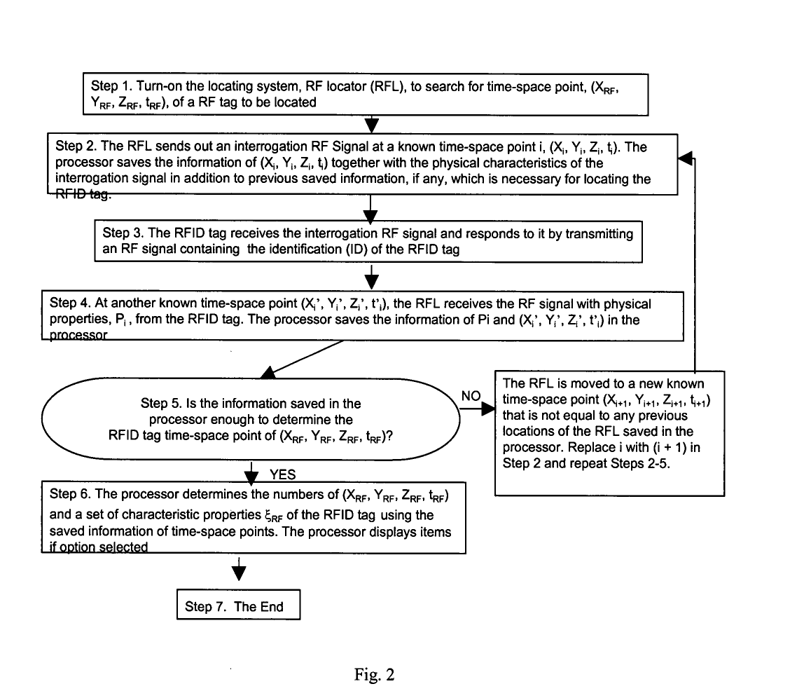

FIG. 2 shows a mobile RFL system to determine the location of an RFID tag by using the information of time-space information collected by the system in a time sequence. At Step 1, the system is turned on to search for location information of an RFID tag to be located within a certain distance. At Step 2, the RFL sends out an interrogation RF signal at the i^{th} time-space point (Xᵢ, Yᵢ, Zᵢ, tᵢ), i=1, 2, . . . , where (Xᵢ, Yᵢ, Zᵢ) and tᵢ represent the i^{th} space coordinates of the RFL and the i^{th} time when the RFL sends out the RF signal, respectively. The space coordinates, (Xᵢ, Yᵢ, Zᵢ), i=1, 2, . . . , of the RFL can be known by a global positioning system (GPS) or predetermined by other methods. The time, tᵢ, i=1, 2, . . . , can be determined by a clock such as, but not limited to, an atomic clock or other methods. The time-space information is transferred and saved to a processor in addition to previous saved information, if any, which is necessary for locating the RFID tag. The information of the time-space point (Xᵢ, Yᵢ, Zᵢ, tᵢ) is transferred and saved to the processor. At Step 3, the RFID tag receives the interrogation RF signal from the RFL and responds by broadcasting an RF signal containing the ID information of the RFID tag and other physical characteristics. This RF signal sent out by the activated RFID tag is called RFID signal. At Step 4, at another known space coordinates, say (Xᵢ′, Yᵢ′, Yᵢ′), and another time, say tᵢ′, which form a new time-space point (Xᵢ′, Yᵢ′, Yᵢ′, tᵢ′), the RFL receives the RFID signal broadcasted by the RFID tag which is activated by the interrogation RF signal from the RFL. The information of the time-space point (Xᵢ′, Yᵢ′, Zᵢ′, tᵢ′) is transferred and saved to the processor. At Step 5, the processor uses the saved time-space information to try to determine the location of the RFID tag. If the system is able to determine the RFID tag location, at Step 6, the processor determines the numbers of space coordinates (X_{RF}, Y_{RF}, Z_{RF}) and a set of characteristic properties ξ_{RF} of the RFID tag and display items if display option is selected. The set of characteristic properties ξ_{RF} includes, but not limited to, systematic response delay time. If the saved time-space information is not enough to determine the RFID tag location with desired accuracy, the RFL is moved to a new known space position with space coordinates (Xᵢ₊₁, Yᵢ₊₁, Zᵢ₊₁) that is not equal to any previous space positions of the RFL saved in the processor and start a new relocation-collection process until the location of the RFID tag is determined with desired accuracy.

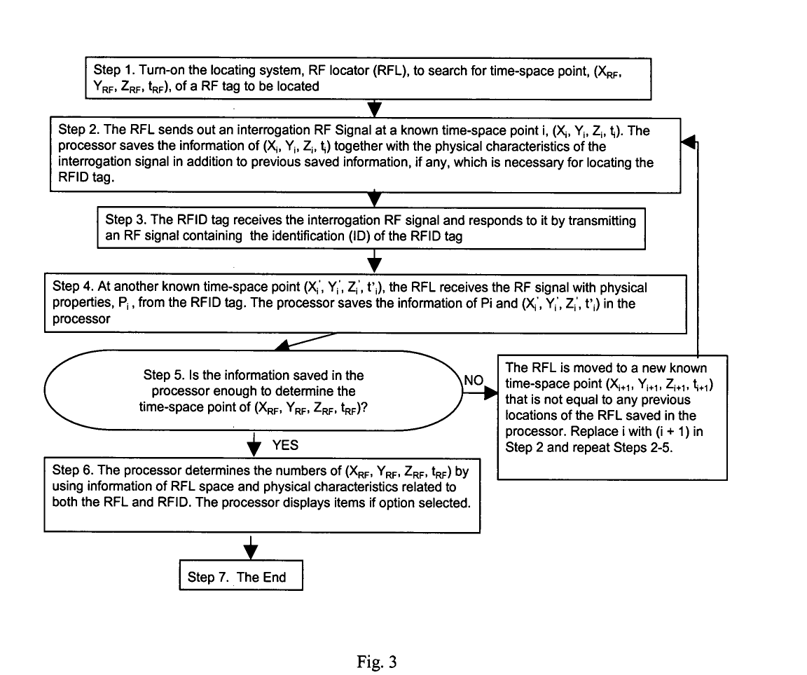

FIG. 3 shows a mobile RFL system to determine the location of an RFID tag by using the information of space of the RFL and RF signal physical characteristics related to both the RFL and RFID tag collected by the system in a time sequence. At Step 1, the system is turned on to search for location information of an RFID tag to be located within a certain distance. At Step 2, the RFL sends out an interrogation RF signal at the i^{th} space point (Xᵢ, Yᵢ, Zᵢ,), where (Xᵢ, Yᵢ, Zᵢ) is the space position of the RFL, i=1, 2, . . . , represent the i^{th} space coordinates of the RFL when the RFL sends out the interrogation RF signal. The space coordinates, (Xᵢ, Yᵢ, Zᵢ), i=1, 2, . . . , of the RFL can be known by a global positioning system (GPS) or predetermined by other methods. The space information and RF signal information related to the RFL are transferred and saved to a processor in addition to previous saved information, if any, which is necessary for locating the RFID tag. At Step 3, the RFID tag receives the interrogation RF signal from the RFL and responds by broadcasting an RF signal containing the ID information of the RFID tag and other physical properties. The RF signal sent out by the RFID tag is called RFID signal. At Step 4, at another known space coordinates, say (Xᵢ′, Yᵢ′, Yᵢ′), the RFL receives the RFID signal from the RFID tag with physical properties, represented by Pᵢ. The Pᵢ includes, but not limited to, physical characteristics such as signal strength and Doppler shift of the wavelength and/or frequency of the RF signal, broadcasted by the RFID tag, which is activated by the RFL. The information of Pᵢ and space point (Xᵢ′, Yᵢ′, Zᵢ′) is transferred and saved to the processor. At Step 5, the processor uses the saved space and physical characteristics of the RF signals information related to both the RFL and the RFID tag to try to determine the location of the RFID tag. If the system is able to determine the RFID tag location. At Step 6, the processor determines the numbers of space coordinates (X_{RF}, Y_{RF}, Z_{RF}) and a set of characteristic properties ξ_{RF} of the RFID tag and display items if option selected. The set of characteristic properties ξ_{RF} includes, but not limited to, systematic response delay time. If the saved information is not enough to determine the RFID tag location with desired accuracy, additional information is obtained by a new relocation-collection process. The RFL is moved to a new position with space coordinates (Xᵢ₊₁, Yᵢ₊₁, Zᵢ₊₁) that is not equal to any previous locations of the RFL saved in the processor and starts the new relocation-collection process. The system collects new information of space and RF signal physical characteristics related to both the RFL and the RFID tag through the new relocation-collection process. After the new relocation-collection process, the processor tries again to determine the location of the RFID tag with the additional collected information and the previously save information of the space and RF signal physical characteristics related to both the RFL and the RFID tag until the location of the RFID tag is determined with desired accuracy. The RFL is used to repeat the above process until the location of the RFID tag is determined with desired accuracy.

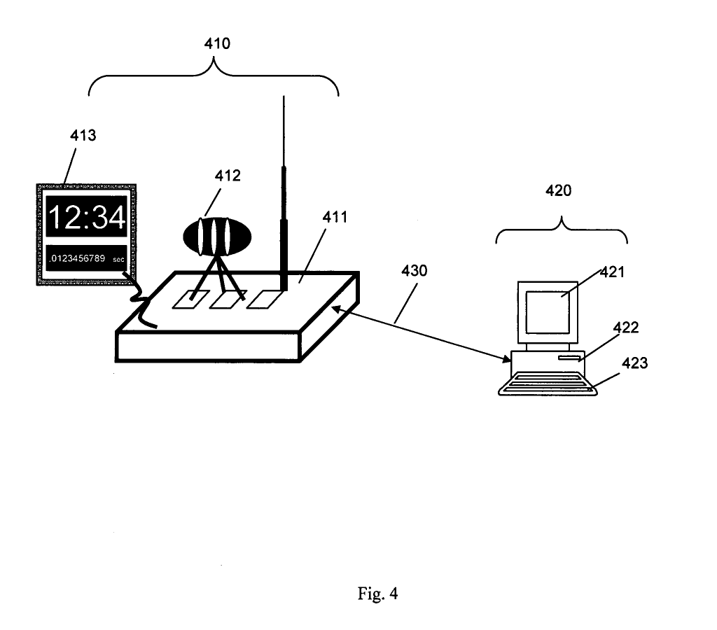

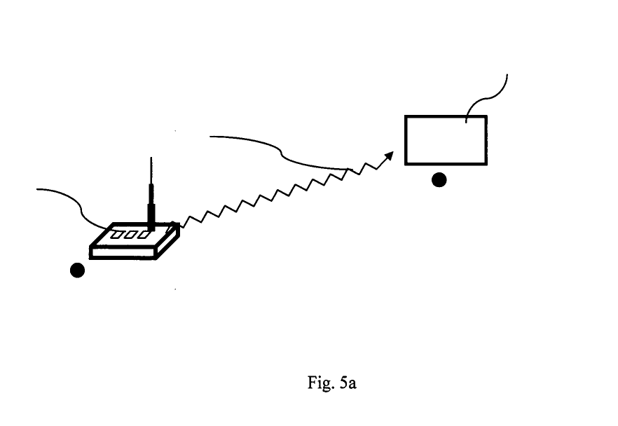

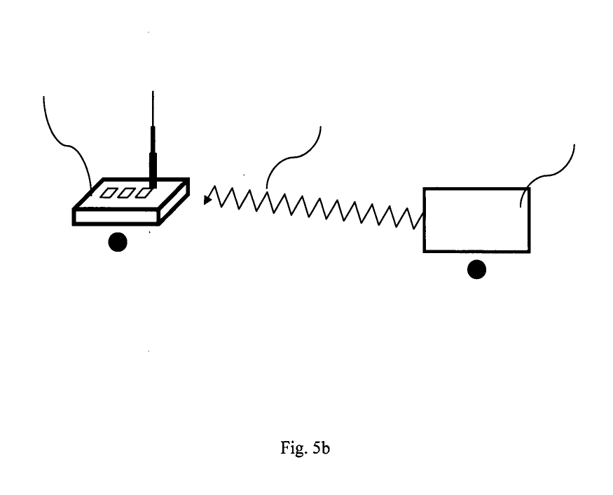

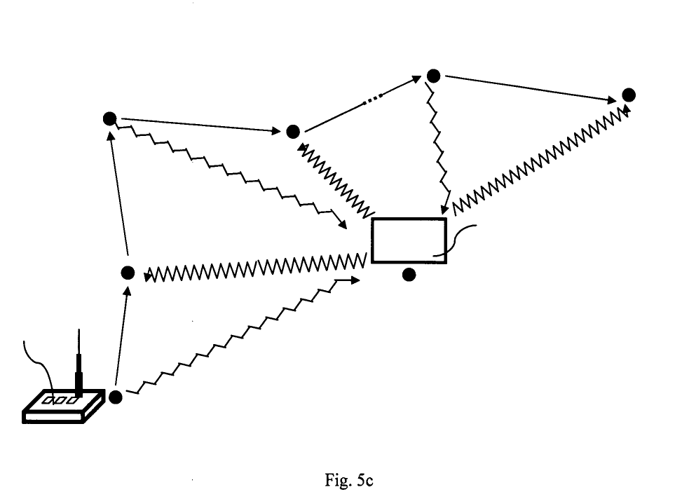

With reference to FIG. 4, With reference to FIG. 4, an example of RFL with processing capability is illustrated. The RFL includes information collector 410 and processor 420, which are connected through cable connection and/or wireless communication 406. The said information collector 410 includes at least on transceiver 411, a global positioning system (GPS) 412 and an atomic clock 405. The said processor 420 is composed of logic and memory units 422, Input/Output (I/O) devices 423 (such as key board, mouse etc) and display monitor 421. The RFL may also include wireless network interface devices and many other additional devices which are not shown and may be configured in different manners from shown.

FIGS. 5 a-c shows an example of a system of using RFL with internal processing capability to determine the location of an RFID tag. In the FIGS. 5a-c, 501 stands for an RFL system; 502 stands for an interrogation RF signal sent out by the RFL system; 503 stands for an RFID tag with position to be located and 504 stands for an RFID signal sent out by the RFID tag after being activated. The RFL 501 may include, but not limited to, at least one RF transceiver, a memory unit, a processor, a clock, a global positioning system (GPS) and I/O devices (such as key board, mouse etc) and display monitor. In one embodiment, as shown in FIG. 5a, at time t₁ determined by a clock and position 1 with space coordinates (X₁, Y₁, Z₁) which is determined by a GPS, the RFL 501 sends out an interrogation RF signal 502 to activate an RFID tag 503 at a position to be located, say (X_{RF}, Y_{RF}, Z_{RF}). The space coordinates (X₁, Y₁, Z₁) and time t₁ forms one time-space point (X₁, Y₁, Z₁, t₁). The RFID tag 503 is activated by the interrogation RF signal 502 from the RFL 501 and broadcasts an RF signal 504 containing ID information. This RF signal 504 broadcasted by the RFID 503 is called RFID signal. In one embodiment, as shown in FIG. 5b, at position (X₁′, Y₁′, Z₁′) and time tₗ′, the RFL 501 receives the RF signal 504 from the RFID tag 503. The space coordinates (X₁′, Y₁′, Z₁′) and time t₁′ forms another time-space point (X₁′, Y₁′, Z₁′, t₁′). The space coordinates (X₁′, Y₁′, Z₁′) may or may not be the same as space coordinates (X₁, Y₁, Z₁, t₁). The RFL 501 records the ID information of the RFID tag 503 together with RF signal 502 and 504 physical properties including, but not limited to, such as signal strength and Doppler shift of the wavelength and/or frequency of the RF signal, broadcasted by the RFID tag 503. The information of time-space point (X₁, Y₁, Z₁, t₁), (X₁′, Y₁′, Z₁′, t₁′) and physical properties of both RF signal 502 and RF signal 504 is transferred and saved to a processor in addition to previous saved information, if any, which is necessary for locating the RFID tag. The processor uses the saved information to try to determine the location of the RFID tag 503 by the methods disclosed in this invention. If the system is able to determine the RFID tag 503 location, the processor determines the numbers of space coordinates (X_{RF}, Y_{RF}, Z_{RF}) of RFID 503 tag and a set of characteristic properties ξ_{RF} of RFID tag 503 and display items. The set of characteristic properties ξ_{RF} includes, but not limited to, systematic response delay time.

If the saved information is not enough to determine the RFID tag location with desired accuracy by the processor, the RFL is moved to the 2^{nd} space position with space coordinates (X₂, Y₂, Z₂), as shown in FIG. 5c. Similar to the steps in FIGS. 5a and 5b, new information of time-space point (X₂, Y₂, Z₂, t₂), (X₂, Y₂, Z₂, t₂) and physical characteristics of RF signal 505 and RFID signal 506 is collected. The processor uses new information of time-space point (X₂, Y₂, Z₂, t₂), (X₂′, Y₂′, Z₂′, t₂′) and physical characteristics of RF signals and RFID signals in addition to previously saved information to try to determine the location of RFID tag 503. If the location of RFID tag 503 is not successfully determined with desired accuracy, the RFL is moved to new time-space point 3, 3′, . . . , i, i′ and so on, to collect new information of time-space point (Xᵢ, Yᵢ, Zᵢ, tᵢ), (Xᵢ′, Yᵢ′, Zᵢ′, tᵢ′) and physical characteristics of RF signal 507 and RFID signal 508 until the location of the RFID tag is successfully determined with desired accuracy.

The configuration shown herein is solely for illustration and not meant to impose any structural/functional limits on RFL. Also, while referred herein as RFL 501 to maintain consistency throughout the description, those skilled in the art appreciate the RFID device may be a functional component within a larger system, such as a portable computer, cellular phone, etc.

Depending on its specific use, RFL 501 may include software units stored in the memory and execute by CPU. Also, if necessary, the RFL communicates with a remote computer system via wireless network interface device.

While the invention has been particularly shown and described with reference to a preferred embodiment, it will be understood by those skilled in the art that various changes in from and detail may be made therein without departing from the spirit and scope of the invention.

What is claimed is:

1) A system for locating an object having an RFID tag, the system comprising:
At least a mobile RF transceiver, the mobile RF transceiver transmitting at several locations and times a plurality of transmitted interrogation RF signals to activate the RFID tag, the mobile RF transceiver at several locations and times receiving a plurality of RFID signals broadcasted from the RFID tag activated by the interrogation RF signals and measuring the strength and/or frequency of a plurality of RFID signals broadcasted from the RFID tag activated by the interrogation RF signal;
at least a positioning device, the positioning device determining the locations where the mobile RF transceiver transmitting a plurality of transmitted interrogation RF signals to activate the RFID tag and receiving a plurality of RF signals broadcasted from the RFID tag activated by the interrogation RF signals;
at least a clock, the clock determining the times when the mobile RF transceiver transmits a plurality of transmitted interrogation RF signals to activate the RFID tag and receives a plurality of RF signals broadcasted from the RFID tag activated by the interrogation RF signals;
at least a processor, the processor saving the locations, the times, the strengths of the RF signals, and the frequencies of the RF signals, the processor calculating the location of the RFID tag;
at least an input device, the input device feeding data into the processor; and
at least an output device, the output device representing data including, but not limited to, the location of the RFID tag.

2) The system of claim 1, wherein said mobile RF transceiver consists of at least one RF transmitter and at least one RF receiver.

3) The system of claim 1, wherein said positioning device is a global positioning system (GPS), a spatial measuring device, and combination therein.

4) The system of claim 1, wherein said clock is atomic clock.

5) The system of claim 1, wherein said processor consists of logic and memory units.

6) The system of claim 1, wherein said input is a keyboard, a voice recognition device, and combination therein.

7) The system of claim 1, wherein said output device is a display, a speaker, an audible instruction device, and combination therein.

8) The system of claim 1, wherein said positioning device is integrated to said mobile RF transceiver.

9) The system of claim 1, wherein said clock is integrated to said mobile RF transceiver.

10) The system of claim 1, wherein said processor is integrated to said mobile RF transceiver.

11) The system of claim 1, wherein said input device is integrated to said mobile RF transceiver.

12) The system of claim 1, wherein said output device is integrated to said mobile RF transceiver.

13) A method for locating an object having an RFID tag, the method comprising:
An mobile RF transceiver transmitting in at least two locations and at least two times a plurality of transmitted interrogation RF signals to activate the RFID tag, the mobile RF transceiver in at least two locations and at least two times receiving a plurality of RFID signals broadcasted from the RFID tag activated by the interrogation RF signals, the mobile RF transceiver measuring RF physical characteristics of the interrogation RF signals and the RFID signals broadcasted from the RFID tag activated by the interrogation RF signals;
a positioning device determining the locations where the mobile RF transceiver transmits a plurality of transmitted interrogation RF signals to activate the RFID tag and receives a plurality of RF signals broadcasted from the RFID tag activated by the interrogation RF signal;
a clock determining the times when the mobile RF transceiver transmits a plurality of transmitted interrogation RF signals to activate the RFID tag and receives a plurality of RFID signals broadcasted from the RFID tag activated by the interrogation RF signal;
a processor saving the locations, the times, RF signal physical characteristics, the processor calculating the location of the RFID tag;
an input device feeding the information of RFID tag into the processor; and
an output representing the locations and the times.

14) The method of claim 13, wherein said processor is a processing component that can be used to save said locations, said times, save said RF physical characteristics of interrogation RF signals and RFID signals, and to determine RFID tag locations with the saved said locations, said times, said physical characteristics of interrogation RF signal and physical characteristics of RFID signals.

15) The method of claim 13, wherein said RF physical characteristics of interrogation RF signals and RFID signals are the strengths of said interrogation RF and said RFID signals, and said interrogation frequencies of the RF and said RFID signals.

16) The method of claim 13, wherein said RFID tag is a passive electric component that transmits a RF signal containing stored identification when the RFID tag gets activated by an interrogation RF signal.

17) The method of claim 13, wherein said physical characteristics are Doppler shift of the wavelength and/or frequency of interrogation RF and said RFID signals.

18) The method of claim 13, wherein said time could be determined by an atomic clock.

19) The method of claim 13, wherein said location could be determined by a global positioning system at where said mobile RF transceiver either transmits said interrogation RF signal or receives said RFID signals broadcasted from the RFID tag activated by said interrogation RF signals.

20) The method of claim 19, wherein said RFID signal is a RF signal transmitted by a RFID tag when the RFID tag gets activated by an interrogation RF signal.
